(19) United States
(12) Patent Application Publication
(10) Pub. No.: US 2009/0065502 A1
(43) Pub. Date: Mar. 12, 2009

(54) POWER CONTROL METHOD OF HIGH FREQUENCY DIELECTRIC HEATING AND APPARATUS THEREOF

(76) Inventors: Haruo Suenaga, Osaka (JP); Kenji Yasui, Nara (JP)

Correspondence Address: PEARNE & GORDON LLP, 1801 EAST 9TH STREET, SUITE 1200, CLEVELAND, OH, 44114-3108, US

(21) Appl. No.: 11/814,174

(22) PCT Filed: Apr. 4, 2006
(86) PCT No.: PCT/JP2006/307128

§ 371 Date: Jul. 18, 2007

(30) Foreign Application Priority Data
Apr. 4, 2005 (JP) 2005-107639

(51) Int. Cl. H05B 6/68

(52) U.S. Cl. 219/716

(57) ABSTRACT

The object of the invention is not only to simplify the structure of a high frequency dielectric heating power control apparatus and reduce the size of the apparatus but also to eliminate the need for control and design corresponding to the kind of a magnetron and thus enhance the running efficiency of the apparatus.

An input current to an inverter circuit is detected by a shunt resistor 71 and is converted to an input current wave form through an input current signal amplifier 72. On the other hand, based on an alternating current power supply voltage wave form from an alternating power supply voltage, there is obtained through a gain variable amplifier 91 a reference wave form following the size of the input current wave form. A wave form error detect circuit 92 compares the input current wave form with the reference wave form to obtain a wave form error signal. A comparison circuit 74 compares the input current wave form with an input current reference signal obtained from an output setting part 75 for obtaining a desired high frequency output to thereby obtain a current error signal. And, a mix and filter circuit 81 adds the wave form error signal and the current error signal to obtain a power control signal for driving a switching transistor 39 of the inverter circuit. Here, the reference wave form is generated based only on the alternating current power supply voltage wave form and on the feedback signal of the wave form error signal.

### TECHNICAL FIELD

The present invention relates to high frequency dielectric heating employed, for example, in a microwave oven using a magnetron and, specifically, the invention relates to high frequency dielectric heating which is free from variations in the characteristics of the magnetron, the kinds of magnetrons, and variations in the temperature of the anode of a magnetron.

### BACKGROUND ART

Conventionally, in a high frequency heating apparatus, power to be supplied to a magnetron is controlled by the output pulse width of an inverter control circuit. According to the structure of the conventional apparatus, as the output voltage of signal superimposing means rises, the output pulse width of the inverter control circuit widens and power to be supplied to the magnetron increases. According to this structure, by varying the output voltage of the signal superimposing means, the heating output of the magnetron can be varied continuously.

Also, since a heater also functions as the cathode of the magnetron, a transformer for supplying power to the magnetron supplies power to the heater as well. Therefore, according to variations in the power to be supplied to the magnetron, the power to be supplied to the heater is varied. As a result of this, when the temperature of the heater is maintained within a proper range, the heating output of the magnetron can be varied only in a very small range, which makes it impossible to vary the heating output continuously.

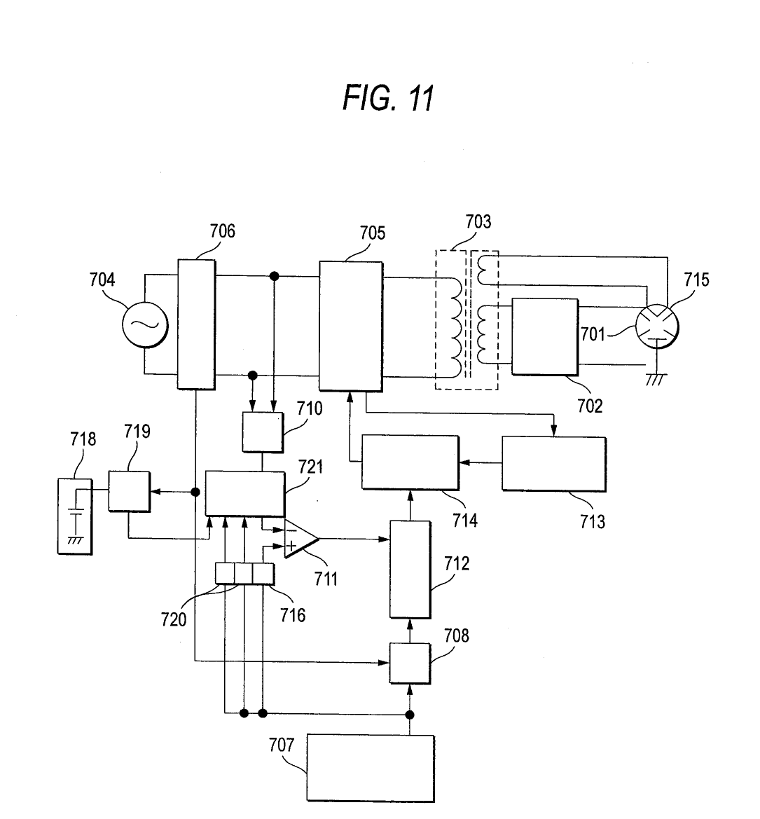

As a control system for solving this problem, there is known a control system employed in a high frequency heating apparatus which is disclosed in the Japanese Patent Publication Hei-7-136375. Now, FIG. 11 is an explanatory view of a high frequency heating apparatus which enforces this control system. In FIG. 11, this heating control system comprises: a magnetron 701; a transformer 703 which not only supplies high-voltage power to a high-voltage rectifier circuit 702 used to supply secondary winding power to the magnetron 701 but also supplies power to the heater 715 of the magnetron 701; an inverter circuit 705 which rectifies an alternating current power supply 704, converts it to an alternating current of a given frequency and supplies the alternating current to the transformer 703; power detect means 706 for detecting the input power or output power of the inverter circuit 705; an output setting part 707 for outputting an output setting signal corresponding to a desired heating output setting; a power control part 708 which compares the output of the power detect means 706 with the output setting signal and controls the direct current level of the power control signal so that it provides a desired heating output; signal generation detect means 719 in which, when the output of the power detect means 706 is equal to or larger than the output level of reference voltage generating means 718, its output, that is, a signal generation detect signal is switched from L0 over to H1; a comparison voltage generating circuit 716 for generating a voltage corresponding to the output setting signal; a wave form shaping circuit 721 for shaping not only a wave form shaping signal obtained by comparing the output setting signal using level conversion circuits 720 but also the output of the rectifier circuit 710 used to rectify the voltage of an alternating current power supply 704 based on the above-mentioned wave form shaping signal and the above-mentioned signal generation detect signal; a comparison circuit 711 which compares the output signal of the wave form shaping circuit 721 with the output of the comparison voltage generating circuit 716, and, when the former is smaller, outputs a comparison reference voltage and, when the former is larger, inversion amplifies it; signal superimposing means 712 which superimposes a signal representing variations in the output of the comparison circuit 711 on the above-mentioned power control signal and outputs a pulse width control signal; an oscillator circuit 713; and, an inverter control circuit 714 which pulse-width modulates the output of the oscillator circuit 713 using the above-mentioned pulse width control signal and drives the inverter circuit 5 using the thus modulated output.

According to the above-mentioned high frequency heating apparatus, the power to be supplied to the magnetron 701 is controlled according to the width of the output pulse of the inverter control circuit 714. As the output voltage of signal superimposing means 712 rises, the output pulse width of the inverter control circuit 714 widens and the power to be supplied to the magnetron 701 increases. In this apparatus, by varying the output voltage of the signal superimposing means 712 continuously, the heating output of the magnetron 701 can be varied continuously.

According to this structure, the rectified voltage of the alternating current power supply 704 is input and is shaped according to the output setting of the wave form shaping circuit 721 which outputs the thus shaped voltage to the comparison circuit 711. The output of the wave form shaping circuit 721 is inversion amplified by the comparison circuit 711 having, as a reference voltage, the voltage of the comparison voltage generating circuit 716 which generates a reference signal of a level corresponding to a heating output setting signal, and this inversion amplified signal and the output of the power control part 708 are superimposed on each other. Therefore, when the heating output is set low, the level of the above-mentioned pulse width control signal, which is the output signal of the signal superimposing means 712, in the vicinity of the maximum amplitude of the alternating current power supply 704 is lowered further, while the level thereof in the magnetron non-oscillatory portion is raised further, thereby extending the oscillating period of the magnetron per power supply cycle. As a result of this, the power to be supplied to the heater is increased. Also, when the heating output is set high, the input current wave form of the inverter circuit 5 projects upward in the vicinity of the envelope peak and provides a wave form near to the rectified wave form of a sine wave, thereby being able to suppress a harmonic current.

In this manner, the pulse width control signal is controlled by the wave form shaping circuit 721 such that, for the low output time, a large amount of heater current can be input, whereas, for the high output time, the power supply current harmonic wave can be reduced. In other words, the power supply current harmonic wave can be suppressed and variations in the heater current can be reduced, thereby being able to realize a highly reliable high frequency heating apparatus.

However, in this control, the on/off drive pulse of a switching transistor is pulse width modulated using the modulated wave form obtained by processing and shaping a commercial power supply wave form; and, a wave form shaping processing according to [an estimated control method] is enforced so that the input current can approach a sine wave. Owing to this, it has been found that the wave form shaping is not able to follow variations in the characteristics of magnetrons, kinds of magnetrons, variations in ebm (a voltage between anode and cathode) due to the temperature of the anode of a magnetron and due to loads within a microwave oven, and variations in the power supply voltage.

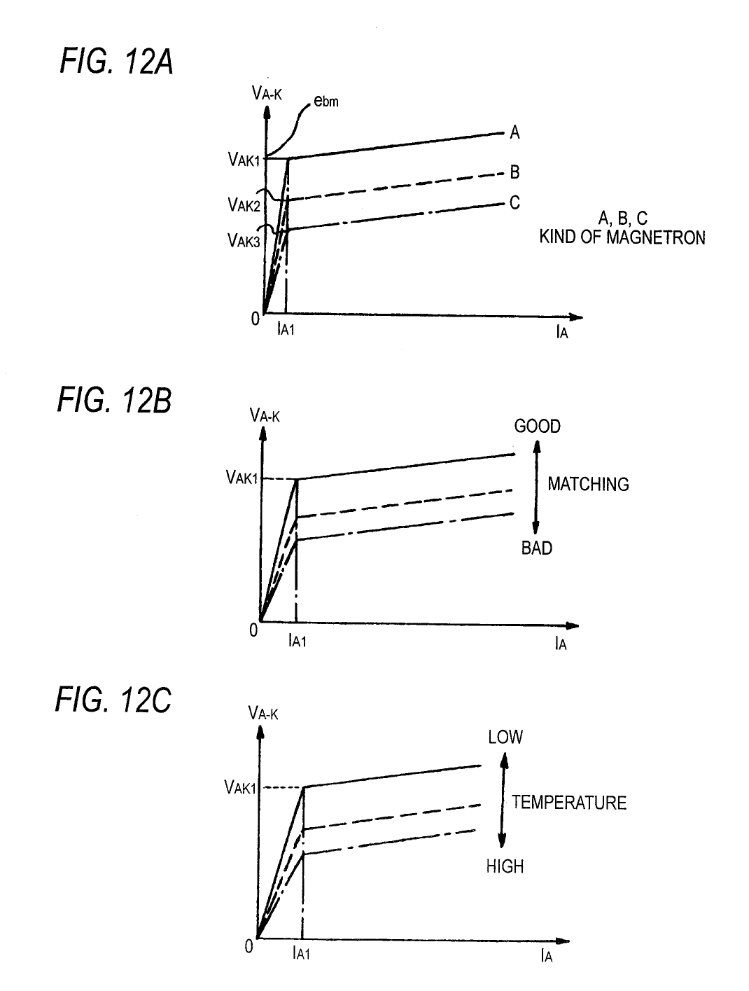

Now, description will be given below in brief of the variations in the characteristics of magnetrons and the kinds of magnetrons. Since the VAK (anode/cathode voltage)-Ib characteristic of a magnetron, as shown in FIG. 12, is a non-linear load, by modulating the on width of a pulse according to the phase of the commercial power supply, the input current wave form is made to approach a sine wave to thereby enhance the power factor thereof.

And, this non-linear characteristic of a magnetron varies according to the kinds of magnetrons and also varies depending on the temperature of the magnetron and loads within a microwave oven.

FIG. 12 is the anode/cathode applied voltage-anode current characteristic view of a magnetron. Specifically, FIG. 12A shows variations depending on the kinds of magnetrons, FIG. 12B shows variations depending on the good or bad matching of the power supply of a magnetron, and FIG. 12C shows variations depending on the temperatures of a magnetron. In common to FIGS. 12A to 12C, the vertical axis expresses a voltage between the anode and cathode of the magnetron, whereas the horizontal axis expresses an anode current.

Referring here to FIG. 12A, A, B and C respectively show three kinds of characteristics of a magnetron. In the case of the magnetron A, until VAK becomes VAK1 (=ebm), only a small current of IA1 or less is allowed to flow. However, when VAK exceeds VAK1, the current IA starts to increase suddenly. In this region, even when VAK varies slightly, IA varies greatly. Next, in the case of the magnetron B, VAK2 (=ebm) is lower than VAK1; and, in the case of the magnetron C, VAK3 (=ebm) is lower than VAK2. In this manner, since the non-linear characteristic of a magnetron varies according to the kinds A, B and C of the magnetron, in the case of a modulated wave form matched to a magnetron having a low ebm, when a magnetron having a high ebm is used, the input current wave form is distorted. The conventional apparatus is not able to cope with this problem. This raises a problem to complete a high frequency dielectric heating circuit which is free from these influences.

Similarly, referring to FIG. 12B, three kinds of magnetron characteristics respectively show the good or bad impedance matching of the heating chamber when viewed from the magnetron side. When the impedance matching is good, VAK1 (=ebm) is the maximum and, as the impedance matching worsens, VAK decreases. In this manner, the non-linear characteristic of the magnetron also varies greatly depending on good or bad of the impedance matching. This raises a problem to complete a high frequency dielectric heating circuit which is free from the influences of these kinds of magnetron characteristics.

Also, similarly, referring to FIG. 12C, three kinds of magnetron characteristics respectively show the high and low temperatures of a magnetron. When the temperature is low, VAK1 (=ebm) is the maximum and, as the temperature rises, the ebm decreases. Because of this, in the case where the temperature of the magnetron is set low, when the temperature of the magnetron becomes high, the input voltage wave form is distorted.

In this manner, because the non-linear characteristic of the magnetron varies greatly according to the temperatures of the magnetron, it is necessary to complete a high frequency dielectric heating circuit which is free from the influences of these kinds of magnetron characteristics.

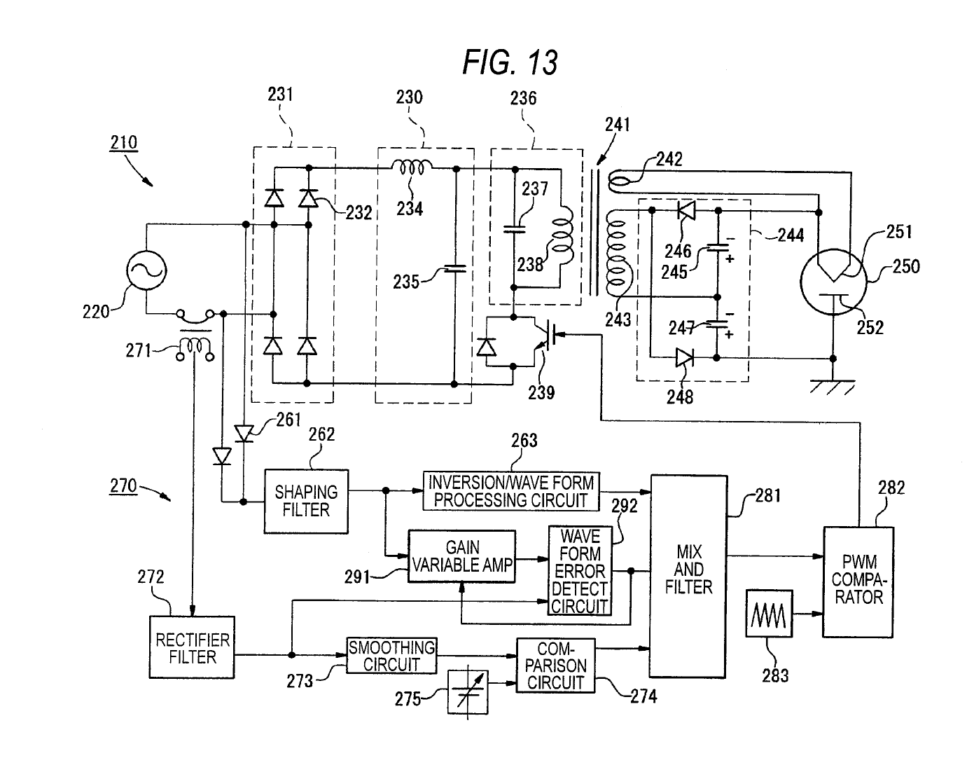

In coping with the above-mentioned problems, there is known a control system disclosed in the Japanese Patent Publication 2004-30981. FIG. 13 is an explanatory view of a high frequency heating apparatus which enforces this control system.

In FIG. 13, the alternating voltage of an alternating current power supply 220 is rectified by a diode bridge type rectifier circuit 231 composed of four diodes 232 and is converted to a direct voltage through a smoothing circuit 230 which is composed of an inductor 234 and a capacitor 235. After then, the direct voltage is converted to a high frequency alternating current not only by a resonance circuit 236 composed of a capacitor 237 and a primary winding 238 of a transformer 241 but also by an inverter circuit composed of a switching transistor 239, with the result that there is induced a high frequency high voltage in a secondary winding 243 of the transformer 241 through the transformer 241.

The high frequency high voltage induced in the secondary winding 243 is applied through a voltage doubler rectifier circuit 244 composed of a capacitor 245, a diode 246, a capacitor 247 and a diode 248 into between the anode 252 and cathode 251 of a magnetron 250. Also, the transformer 241 further includes a tertiary winding 242 and the heater (cathode) 251 of the magnetron 250 is heated by the tertiary winding 242. The above-mentioned structure constitutes an inverter main circuit 210.

Next, description will be given below of a control circuit 270 which is used to control the switching transistor 239 of the inverter. Firstly, the input current of the inverter circuit is detected using current detect means 271 such as CT, and a current signal from the current detect means 271 is rectified by a rectifier circuit 272 and is smoothed by a smoothing circuit 273; and, this signal is compared with a signal from an output setting part 275 which outputs an output setting signal corresponding to the other heating output setting, by a comparison circuit 274. By the way, since the comparison circuit 274 makes a comparison for controlling the intensity of power, the present invention is also effective even when the input signal is composed of the anode current signal of the magnetron 250, the collector current signal of the switching transistor 239 or the like instead of the above-mentioned input current signal.

On the other hand, the alternating current power supply 220 is rectified by a diode 261 and the wave form thereof is then shaped by a shaping circuit 262. After then, a signal from the shaping circuit 262 is inverted and wave form processed by an inversion/wave form processing circuit 263.

An output signal from the shaping circuit 262 is gain varied by a gain variable amplifier circuit 291 (which will be discussed later) provided according to the invention to thereby output a reference wave form signal; and, a difference between the input current wave form signal from the rectifier circuit 272 and the reference wave form signal from the gain variable amplifier circuit 291 is output as a wave form error signal by a wave form error detect circuit 292 which is also provided according to the invention.

The wave form error signal from the wave form error detect circuit 292 and the current error signal from the comparison circuit are mixed and filtered by a mix and filter circuit 281 (which is hereinafter referred to as a mix circuit) to thereby output an on voltage signal, the on voltage signal is compared with a saw tooth wave form from a saw tooth wave generating circuit 283 by a PWM comparator 282, and is pulse width modulated, thereby controlling the on and off of the switching transistor 239 of the inverter circuit.

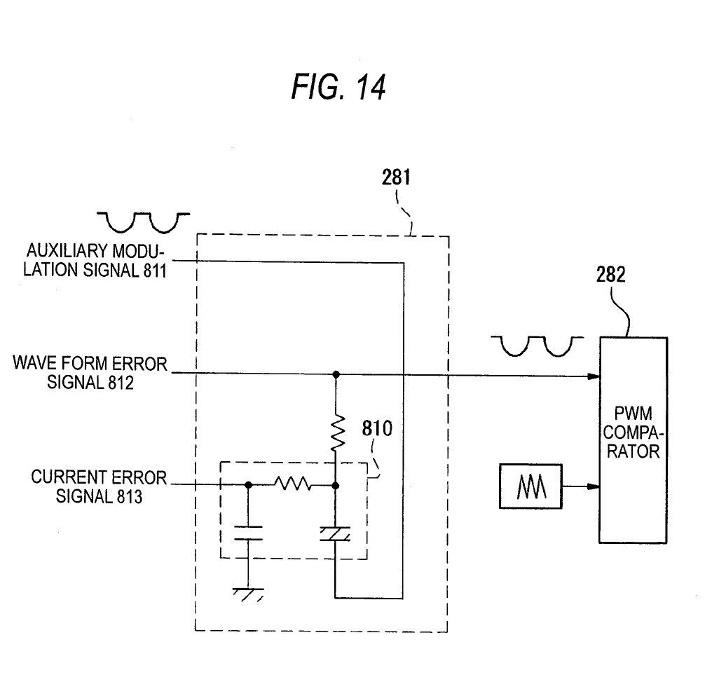

Now, FIG. 14 shows an example of the mix circuit 281. The mix circuit 281 has three input terminals. Specifically, an auxiliary modulation signal is applied to a terminal 811, a wave form error signal is applied to a terminal 812, and a current error signal is applied to a terminal 813; and, these signals are mixed by such an internal circuit as shown in FIG. 14.

Reference numeral 810 designates a high frequency wave cut filter having a function to remove the high frequency component of a current error signal in which the high frequency component is not necessary. The reason for removal of the high frequency component is as follows: that is, if the high frequency component is present in the current error signal, when the current error signal is mixed with a wave form error signal, the varying components of the wave form error signal are prevented from appearing clearly.

In the above-mentioned manner, a wave form reference following the intensity of the input current is automatically created by the gain variable amplifier circuit 291, this wave form reference is compared with the input current wave form obtained from current detect means 271 by the wave form error detect circuit 292 to thereby obtain wave form error information, the thus obtained wave form error information is mixed with the output of the input current control, and the resultant information is used for conversion of the on/off drive signal of the switching transistor 239 of the inverter circuit.

In this manner, since a control loop is operated in such a manner that the input current wave form coincides with the wave form reference following the intensity of the input current, even when the kinds and characteristics of the magnetron vary, also even when the ebm (voltage between anode and cathode) varies due to the temperature of the anode of the magnetron and/or loads within a microwave oven, and further even when the power supply voltage varies, the input current wave form can be shaped free from the influences of these factors.

### DISCLOSURE OF THE INVENTION

### Problems that the Invention is to Solve

However, according to the structure disclosed in the Japanese Patent Publication 2004-30981, as shown in FIG. 14, the wave form is shaped using the auxiliary modulation signal 811 from the inversion/wave form processing circuit 263. This is based on the reason that, in shaping the wave form, by using the auxiliary modulation signal 811 in addition to the wave form error signal 812 reflecting a current flowing actually, the wave form shaping can be attained well. However, not only the employment of the inversion/wave form processing circuit 263 but also the need of the rectifier circuit 272 make the structure complicated and large in scale.

And, with the employment of the auxiliary modulation signal 811, it is necessary to control the auxiliary modulation signal 811 according to the kinds and characteristics of magnetrons, which in the long run makes it necessary to design the structure individually for each of circuits corresponding to the magnetrons to be used.

Also, with the employment of the auxiliary modulation signal 811, the time of the start of the first on operation of the transistor 239 must be controlled to a phase in the vicinity of 0 degree and 180 degrees where the instantaneous voltage of the alternating current power supply is low, thereby preventing a high voltage from being applied to the magnetron. However, this results in the complicated control.

It is an object of the invention to realize high frequency dielectric heating power control method and apparatus which not only can simplify the structure of a heating apparatus to thereby reduce the size of the heating apparatus but also can eliminate the need of the above-mentioned control and design corresponding to the kinds of magnetrons to thereby be able to enhance the running efficiency of the apparatus.

### Means for Solving the Problems

A high frequency dielectric heating method according to the invention is a high frequency dielectric heating power control method for controlling an inverter circuit which rectifies and high frequency switches an alternating current power supply voltage to convert it to high frequency power, the method comprising the steps of: (1) detecting an input current to the inverter circuit to obtain an input current wave form; (2) obtaining a reference wave form following the intensity of the input current wave form based on an alternating current power supply voltage wave form from the alternating current power supply voltage; (3) comparing the input current wave form with the reference wave form to obtain a wave form error signal; (4) comparing the input current wave form with an input current reference signal for obtaining a desired high frequency output to obtain a current error signal; (5) adding the wave form error signal and the current error signal to obtain a power control signal for driving a switching transistor of the inverter circuit; and, (6), in the step (2), generating the reference wave form based only on the alternating current power supply voltage wave form and a feedback signal of the wave form error signal obtained in the step (3).

In the above method, the reference wave form can be obtained by converting a commercial power supply voltage wave form through a gain variable amplifier. Also, prior to the step (5), the wave form can be limited in the positive and negative directions of the wave form error signal. Further, in the step (6), the high frequency component of the feedback signal can be removed.

Next, a high frequency wave dielectric heating apparatus according to the invention is a high frequency wave dielectric heating power control apparatus for controlling an inverter circuit which rectifies and high frequency switches an alternating current power supply voltage to convert it to high frequency power. Specifically, the present apparatus comprises: a current detect part for detecting an input current to the inverter circuit; a first wave form conversion part for converting the input current to an input current wave form; a second wave form conversion part for obtaining a reference wave form following the intensity of the input current wave form based on an alternating current power supply voltage wave form from the alternating current power supply voltage; a wave form error detect circuit for comparing the input current wave form with the reference wave form to obtain a wave form error signal; a comparison circuit for comparing the input current wave form with an input current reference signal for obtaining a desired high frequency output to obtain a current error signal; and, a mix circuit for adding the wave form error signal and the current error signal to obtain a power control signal for driving a switching transistor of the inverter circuit, wherein the reference wave form is generated based only on the alternating current power supply voltage wave form and a feedback signal of the wave form error signal.

The reference wave form can be obtained by converting a commercial power supply voltage wave form through the second wave form conversion part. The second wave form conversion part can be composed of a gain variable amplifier.

And, it is possible to provide a limiter which limits the wave form in the positive and negative directions of the wave form error signal. Also, it is also possible to further provide a high frequency component cut filter which cuts off the high frequency component of the feedback signal.

The first wave form conversion part can also be composed of an input current signal amplifier, and the current detect part can also be composed of a shunt resistor interposed between the alternating current power supply voltage and the inverter circuit.

### EFFECTS OF THE INVENTION

According to the invention, the structure of the heating apparatus can be simplified and thus the apparatus can be reduced in size. Also, there is eliminated the need for control and design of the apparatus corresponding to the kinds of magnetrons used and thus the running efficiency of the apparatus can be enhanced.

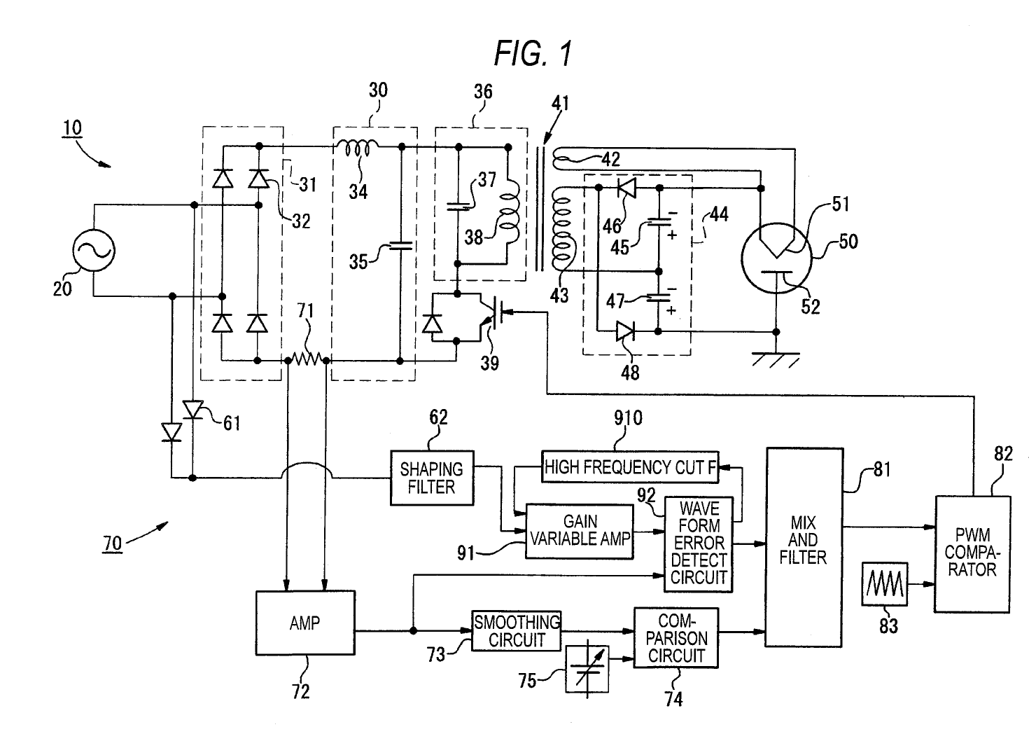

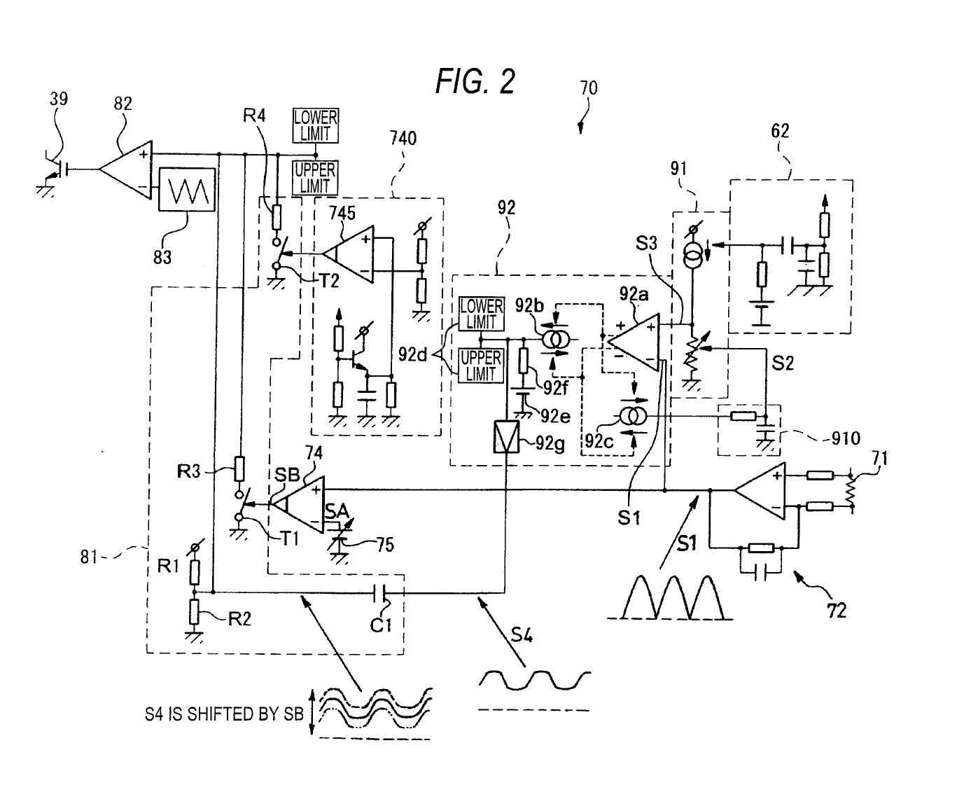

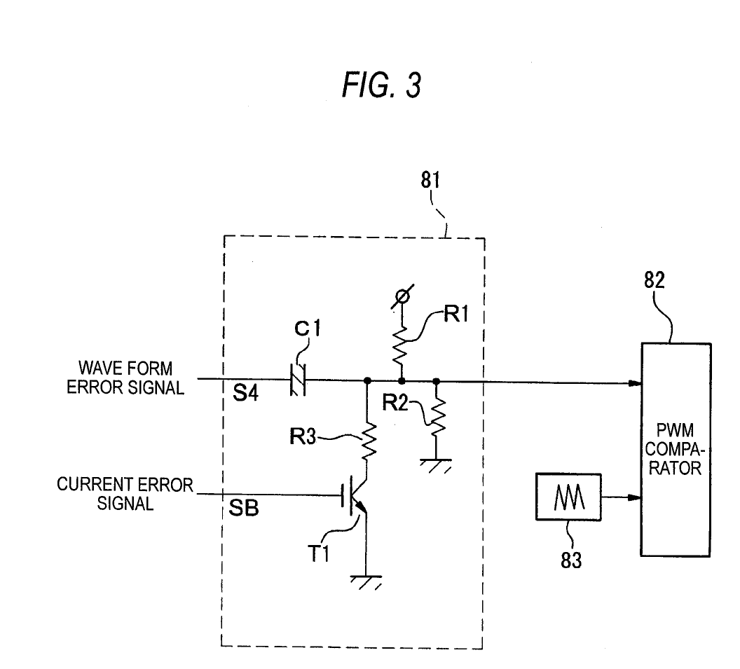

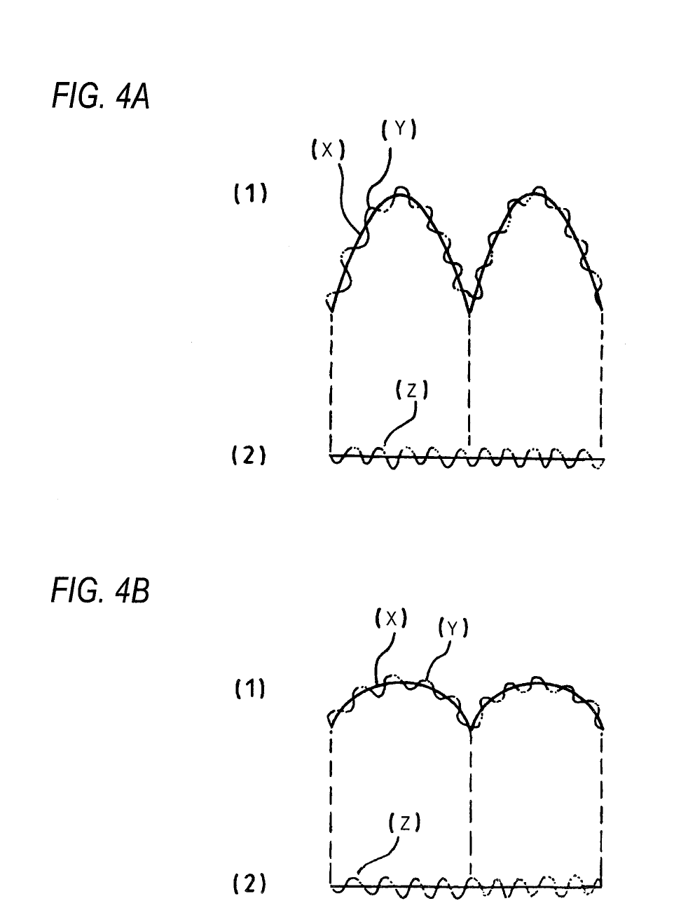

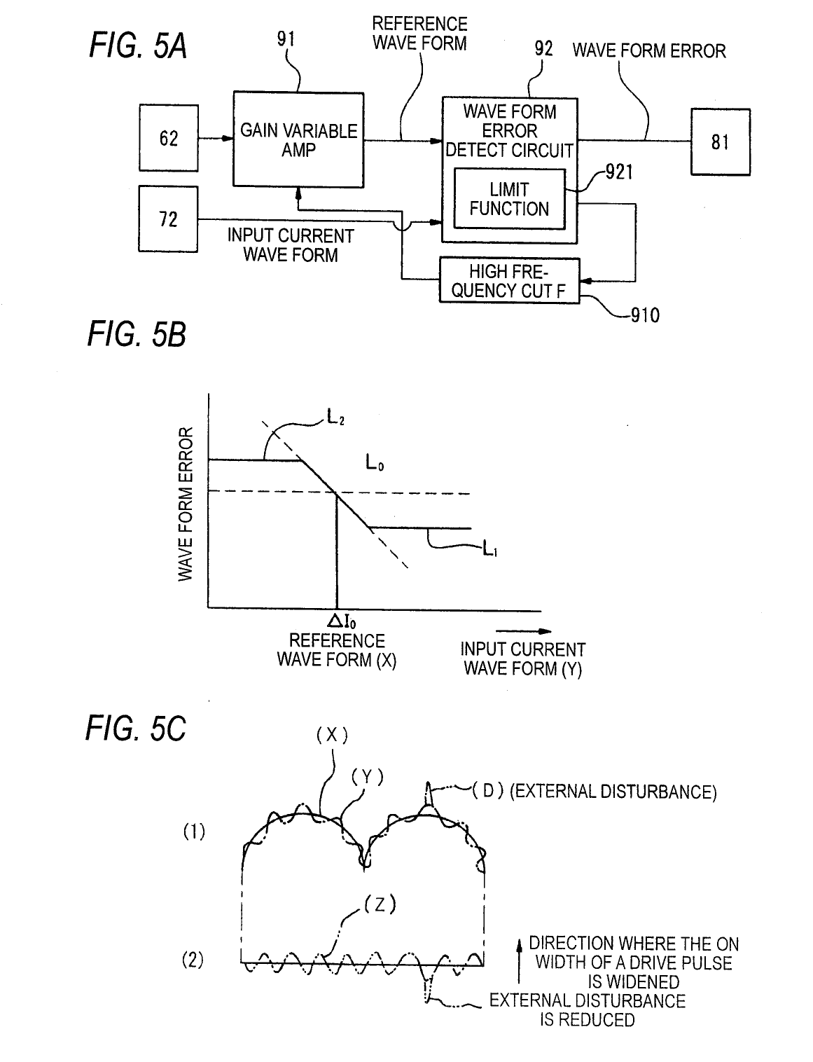

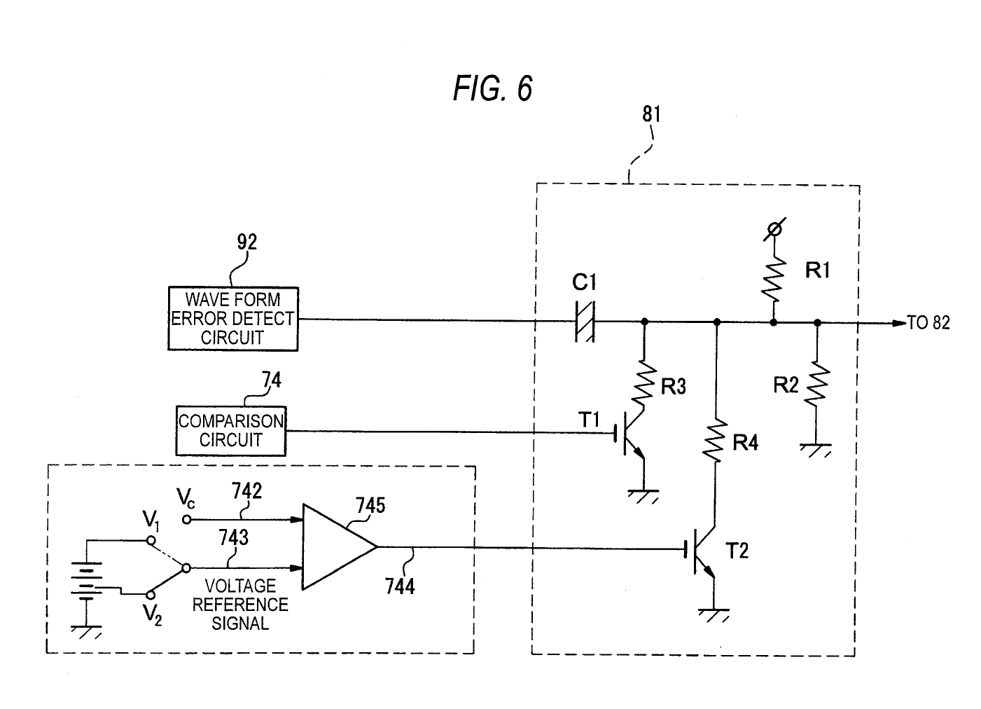

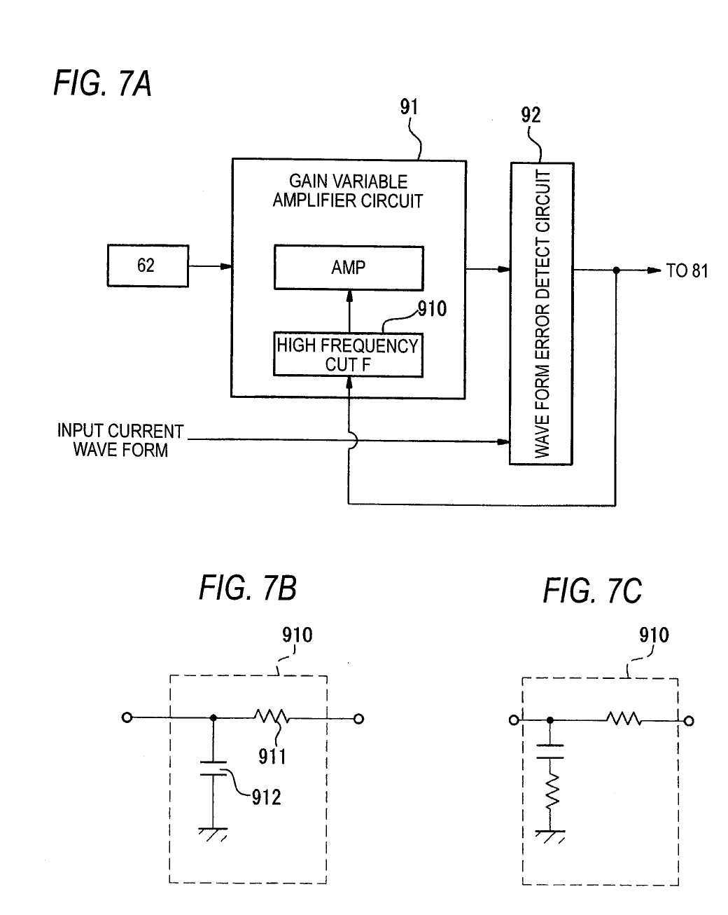

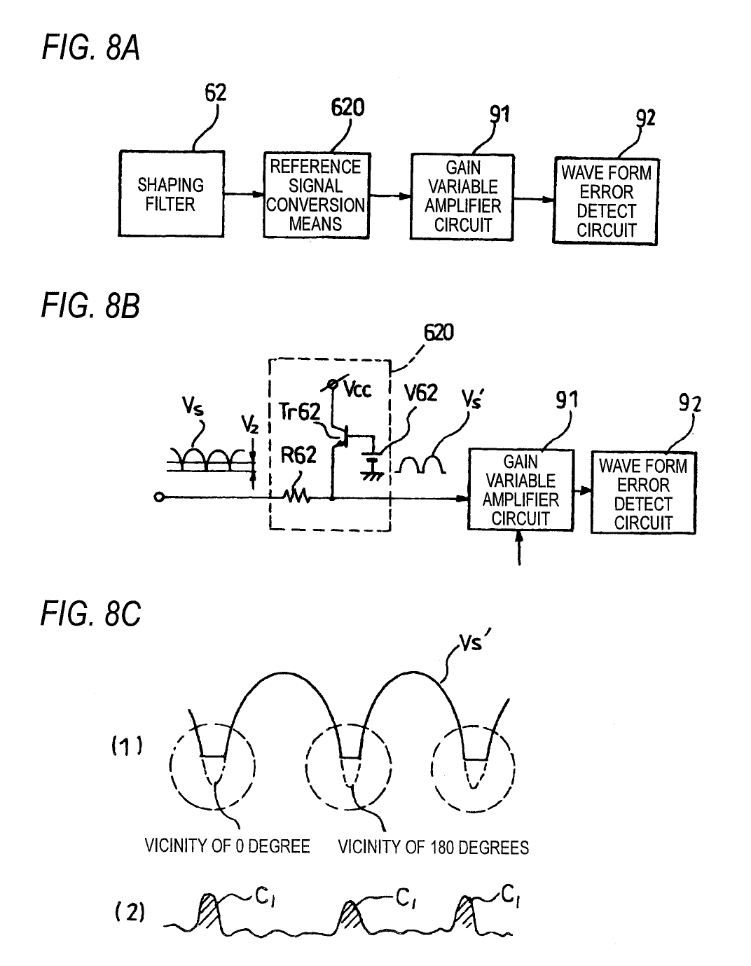

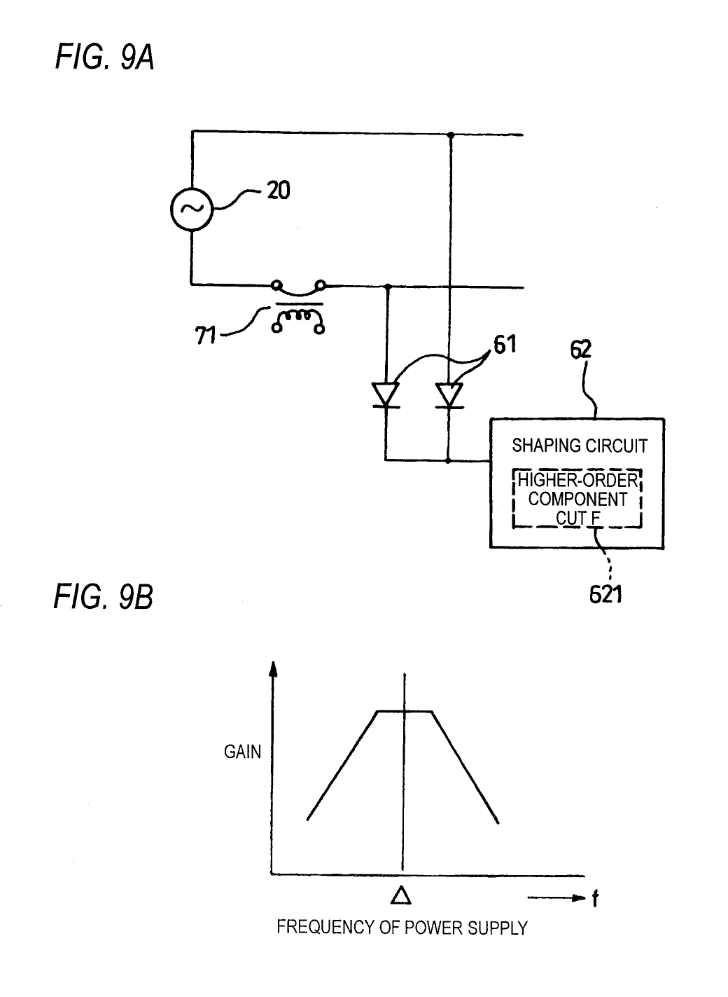

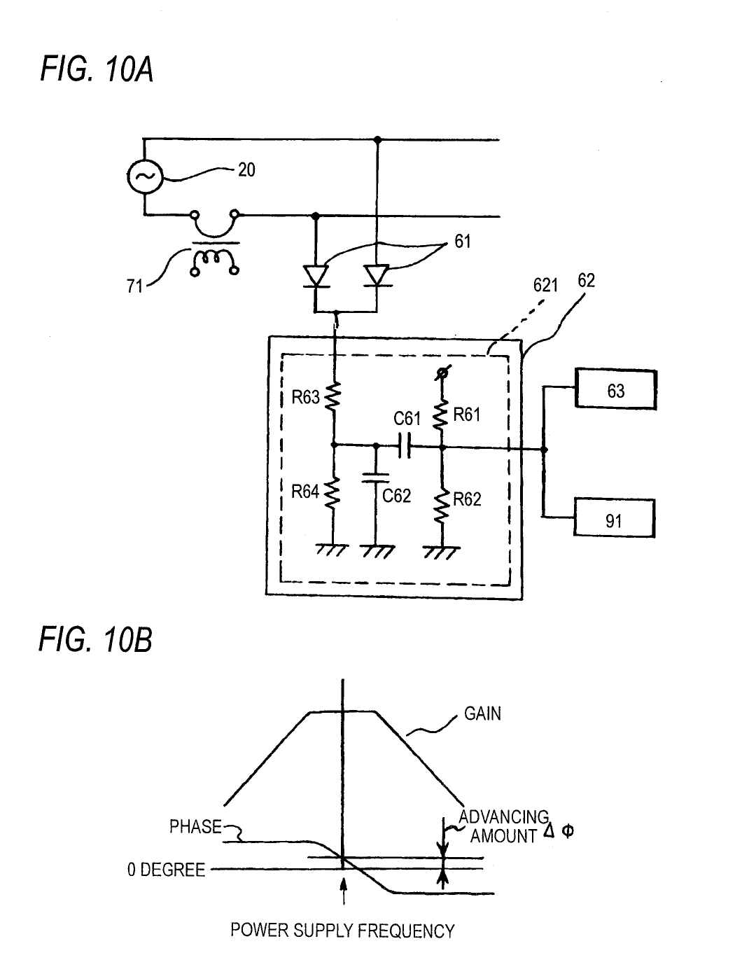

### BRIEF DESCRIPTION OF THE DRAWINGS

[FIG. 1] It is a structure view of a high frequency heating apparatus according to an embodiment 1 of the invention.

[FIG. 2] It is a circuit diagram of the details of a control circuit employed in the high frequency heating apparatus shown in FIG. 1.

[FIG. 3] It is a circuit diagram of a mix circuit employed in the high frequency heating apparatus shown in FIG. 1.

[FIG. 4] It is a view of the wave forms of the input and output signals of a wave form error detect circuit employed in the high frequency heating apparatus shown in FIG. 1. Specifically, FIG. 4A shows a case where an input current is large, and FIG. 4B shows a case where the input current is small.

[FIG. 5] It is an explanatory view of an embodiment 2 according to the invention. Specifically, FIG. 5A is a block diagram of the embodiment 2, FIG. 5B is a characteristic view thereof, and FIG. 5C is a wave form view.

[FIG. 6] It is an explanatory view of a structure for adding a Vc limiter function according to an embodiment 3 of the invention to a current control output. Specifically, FIG. 6A is a structure view of the embodiment 3 and FIG. 6B is an example of a concrete circuit.

[FIG. 7] It is an explanatory view of an embodiment 4 according to the invention. Specifically, FIG. 7A is a block diagram of the embodiment 4, showing an example in which a high frequency component cut filter is included in a gain amplifier circuit, and FIGS. 7B and 7C respectively show examples of a high frequency component cut filter.

[FIG. 8] It is an explanatory view of a reference signal conversion circuit used in an embodiment 5 according to the invention. Specifically, FIG. 8A is a block diagram of the reference signal conversion circuit, FIG. 8B shows an example of the reference signal conversion circuit shown in FIG. 8A, and FIG. 8C shows a wave form; more specifically, FIG. 8C (1) shows a reference wave form and FIG. 8C (2) shows a wave form error signal.

[FIG. 9] It is an explanatory view of an embodiment 6 according to the invention. Specifically, FIG. 9A is a circuit diagram of the embodiment 6 and FIG. 9B is a gain-frequency characteristic view.

[FIG. 10] It is an explanatory view of an embodiment 7 according to the invention. Specifically, FIG. 10A is a circuit diagram of the embodiment 7 and FIG. 10B is an explanatory view of the phase advance of a reference wave form.

[FIG. 11] It is a structure view of a high frequency heating apparatus for enforcing a conventional control method.

[FIG. 12] It is an anode/cathode applied voltage-anode current characteristic view of a magnetron. Specifically, FIG. 12A shows the kinds of magnetrons, FIG. 12B shows the power supply matching of magnetrons, and FIG. 12C shows the temperatures of magnetrons.

[FIG. 13] It is a structure view of a conventional high frequency heating apparatus.

[FIG. 14] It is a circuit diagram of an example of a mix circuit employed in the apparatus shown in FIG. 13.

### DESCRIPTION OF REFERENCE NUMERALS

10: Inverter main circuit
20: Alternating current power supply
30: Smoothing circuit
31: Diode bridge type rectifier circuit
32: Diode
34: Inductor
35: Capacitor
36: Resonance circuit
37: Capacitor
38: Primary winding
39: Switching transistor
41: Transformer
42: Tertiary winding
43: Secondary winding
45: Capacitor
46: Diode
47: Capacitor
48: Diode
50: Magnetron
51: Cathode
52: Anode
61: Diode
62: Shaping circuit
70: Control circuit
71: Shunt resistor
72: Input current signal amplifier
73: Smoothing circuit
74: Comparison circuit
75: Output setting part
81: Mix and filter circuit
82: PWM comparator
83: Saw tooth wave generating circuit
91: Gain variable amplifier circuit
620: Reference signal conversion circuit
740: Comparator
910: High frequency component cut filter
921: Limit circuit

### BEST MODE FOR CARRYING OUT THE INVENTION

Now, description will be given below in detail of embodiments according to the invention with reference to the accompanying drawings.

### Embodiment 1

FIG. 1 is an explanatory block diagram of a high frequency heating apparatus according to an embodiment 1 of the invention. In FIG. 1, the high frequency heating apparatus is composed of an inverter main circuit 10, a control circuit 70 for controlling a switching transistor 39 of the inverter main circuit 10, and a magnetron 50. The inverter main circuit 10 includes an alternating current power supply 20, a diode bridge type rectifier circuit 31, a smoothing circuit 30, a resonance circuit 36, a switching transistor 39, and a voltage doubler rectifier circuit 44.

The alternating voltage of the alternating current power supply 20 is rectified by the diode bridge type rectifier circuit 31 composed of four diodes 32 and is converted to a direct voltage through the smoothing circuit 30 which is composed of an inductor 34 and a capacitor 35. After then, the direct voltage is converted to a high frequency alternating current by the resonance circuit 36, which is composed of a capacitor 37 and a primary winding 38 of a transformer 41, and an inverter circuit composed of the switching transistor 39; and, there is induced a high frequency high voltage through the transformer 41 in the secondary winding 43 thereof.

The high frequency high voltage induced in the secondary winding 43 is applied through the voltage doubler rectifier circuit 44 composed of a capacitor 45, a diode 46, a capacitor 47 and a diode 48 into between the anode 52 and cathode 51 of the magnetron 50. Also, the transformer 41 has a tertiary winding 42, while the heater (cathode) 51 of the magnetron 50 is heated by the tertiary winding 42. The above-mentioned structure constitutes the inverter main circuit 10.

Next, description will be given below of the control circuit 70 for controlling the switching transistor 39 of the inverter main circuit 10. Firstly, the two end portions of a shunt resistor (a current detect part) 71, which is interposed between the diode bridge type rectifier circuit 31 and smoothing circuit 30, are respectively connected to an input current signal amplifier (a first wave form conversion part) 72. A current flowing in the shunt resistor 71 is detected and amplified by the input current signal amplifier 72, thereby generating an input current wave form.

A current signal obtained by the input current signal amplifier 72 is smoothed by a smoothing circuit 73. This signal is compared with a signal from an output setting part 75, which outputs an output setting signal corresponding to the other heating output setting, by a comparison circuit 74. By the way, since the comparison circuit 74 makes a comparison for controlling the intensity of power, instead of the above-mentioned input current signal, there can also be used the anode current signal of the magnetron 50, or the collector current signal of the switching transistor 39, or the like as an input signal.

On the other hand, the alternating current power supply 20 is rectified by a diode 61 connected to the power supply 20 and the wave form thereof is then shaped by a shaping circuit 62. The output signal of the shaping circuit 62 is input to a gain variable amplifier circuit (a second wave form conversion part) 91, while the gain variable amplifier circuit 91 varies the gain of the input signal to thereby output a reference wave form signal (a reference current wave form signal); and, a difference between the input current wave form signal from the input current signal amplifier 72 and the reference wave form signal from the gain variable amplifier circuit 91 is output as a wave form error signal by a wave form error detect circuit 92.

The wave form error signal from the wave form error detect circuit 92 and the current error signal from the comparison circuit 74 are mixed and filtered by a mix and filter circuit 81 (which is hereinafter referred to as a mix circuit), while the mix circuit outputs the resultant signal as an on voltage signal; and, this on voltage signal is compared with a saw tooth wave from a saw tooth wave generating circuit 83 by a PWM comparator 82, and is modulated in the pulse width thereof, thereby controlling the on and off of the switching transistor 39 of the inverter main circuit 10.

Now, FIG. 2 shows the details of the control circuit 70. Although the configurations of the control circuit 70 in FIG. 2 are almost the same as in FIG. 1, in FIG. 2, the smoothing circuit 73 is omitted. In other words, in FIG. 1 as well, the smoothing circuit 73 can be omitted: that is, the current signal obtained from the input current signal amplifier 72 is not smoothed but is input directly to the comparison circuit 74, where it can be compared with the signal from the output setting part 75. Also, a comparator 740 shown in FIG. 2 is omitted in FIG. 1. The comparator 740 is connected through a transistor T2 to the resistor R3 of a mix circuit 81 which will be discussed later. Description will be given later of the comparator 740 as well.

Now, description will be given below in more detail of the operation of the control circuit 70 with reference to FIG. 2. The input current signal amplifier 72 detects an input current wave form S1 which corresponds to a current flowing through the shunt resistor 71. The wave form S1 is smoothed by the smoothing circuit 73 (however, as described above, this smoothing operation is not indispensable and thus the smoothing circuit 73 is omitted in FIG. 2).

On the other hand, the current of the alternating current power supply 20 is rectified by the diode 61 (FIG. 1) and the wave form of the current is shaped by the shaping circuit 62 to thereby generate an alternating current power supply voltage wave form. This alternating current power supply voltage wave form is input to the gain variable amplifier circuit 91. Based on the alternating current power supply voltage wave form and a feedback signal S2 which is obtained by the wave form error detect circuit 92 (which will be discussed later) through a high frequency component cut filter 910 and also which is used to control a gain, the gain variable amplifier circuit 91 finds a reference wave form S3. This reference wave form S3 is generated according to a feedback signal S2 which has the input current wave form S1 as its base. In other words, the reference wave form S3 follows the size of the wave form S1.

The input current wave form S1 and reference wave form S3 following this input current wave form S1 are output to the wave form error detect circuit 92. The wave form error detect circuit 92 compares the input current wave form S1 and reference wave form S3 to thereby generate a wave form error signal S4. This wave form error signal S4 is used to execute a power control corresponding to variations in (instantaneous) input power in a relatively short period unit, namely, a so called wave shaping operation; and, the wave form error signal S4 is output to a mix circuit 81 which will be discussed later. By the way, a comparator 92a is used to compare the input current wave form S1 and reference wave form S3 directly, a current supply 92b is used to generate a forward side signal which provides the base of the wave form error signal S4, and a current supply 92c is used to generate a feedback side signal S2 which is fed to the high frequency component cut filter 910. The intensity and polarity of the currents of the current supplies 92b and 92c reflect the output of the comparator 92a. Moreover, the wave form error detect circuit 92 further includes a limiter circuit 92d, a power supply 92e and a resistor 92f which are used to apply bias, and a buffer circuit 92g.

On the other hand, the above-mentioned input current wave form S1, which has been smoothed by the smoothing circuit 73 (FIG. 1), is output to the comparison circuit 74. The comparison circuit 74 compares the input current wave form S1 with an input current reference signal SA which corresponds to the heating output setting from the output setting part 75. As a result of this comparison, a current error signal SB is generated and is then output to the mix circuit 81. When this current error signal SB is larger than 0, that is, when (input current wave form S1)>(input current reference signal SA), a transistor T1 of the mix circuit 81 is turned off.

Next, description will be given below of the mix circuit 81. As shown in FIGS. 2 and 3, the mix circuit 81 includes the above-mentioned transistor T1 connected to the comparison circuit 74, a capacitor C1 connected to the wave form error detect circuit 92, and three resistors R1, R2, R3. By the way, in FIG. 2, the mix circuit 81 includes a transistor T2 and a resistor R4 which are additionally shown and are respectively connected to the comparator 740; however, in FIG. 3, they are omitted.

The mix circuit 81 adds the wave form error signal S4 from the above-mentioned wave form error detect circuit 92 and the current error signal SB from the comparison circuit 74, and outputs the resultant signal as a power control signal (an on voltage signal). This adding operation (mixing operation), as described in connection with FIG. 2, corresponds to the shift (vertical shift) of the absolute value of the wave form error signal S4 due to the current error signal SB.

And, the saw tooth wave from the saw tooth wave generating circuit 83 and the power control signal are compared with each other for pulse width modulation by the PWM comparator 82, thereby controlling the on and off of the switching transistor 39 of the inverter main circuit 10.

As described above, the reference wave form following the size of the input current wave form is automatically created by the gain variable amplifier circuit 91, the thus-created reference wave form and the input current wave form obtained from the shunt resistor 71 are compared with each other by the wave form error detect circuit 92 to obtain the wave form error signal, and the thus obtained wave form error signal is mixed with the current error signal that is the output of the comparison circuit 74, whereby the resultant signal is used as the on and off drive signal of the switching transistor 39 of the inverter main circuit 10.

Now, FIG. 4 is an explanatory view of a wave form which can be obtained according to the present embodiment. Specifically, FIG. 4A shows a wave form obtained when an input current is large, whereas FIG. 4B shows a wave form when the input current is small. Also, (1) and (2) respectively show the input side signal (in which X designates a reference current wave form and Y stands for an input current wave form) and output side signal (a wave form error) of the wave form error detect circuit 92. In FIG. 4, the reference wave form varies in size while following the input current. Therefore, not only when the input current is large (FIG. 4A) but also when the input current is small (FIG. 4B), in the output side signal (a wave form error) of the wave form error detect circuit 92, like (2), only the wave form error thereof appears; and thus, the dynamic range of the wave form error detect circuit 92 for creating a wave form error signal is always kept wide, thereby improving the characteristics of the wave form error detect circuit 92.

In this manner, since the control loop of the mix circuit 81 operates such that the input current wave form coincides with the reference wave form following the size of the input current, even when the magnetron varies in the kind and characteristics thereof, also even when the ebm (voltage between the anode and cathode of the magnetron) varies due to the temperature of the magnetron and/or due to loads within a microwave oven, and further even when the power supply voltage varies, the wave form of the input current can be shaped free from the influences of these variations.

Also, a commercial power supply voltage wave form is used and it is converted to a reference wave form through the gain variable amplification circuit 91, whereby the power factor of the input signal can be made optimum. That is, because the commercial power supply voltage is rectified to thereby generate the reference current signal wave form, as the commercial power supply voltage approaches a sine wave, the reference current signal wave form also approaches a sine wave. Also, generally, the commercial power supply voltage involves a wave form distortion (especially, a wave form distortion in which the peak portion of a sine wave collapses). In such case, the reference current signal wave form also distorts in the same manner. In the long run, in both cases, the reference current signal wave form includes such wave form and the input current wave form approaches this reference current signal wave form, with the result that the input current wave form is free from the power supply environment and thus the power factor can be enhanced. On the other hand, conventionally, there has been generally used a method for generating a reference voltage using a microcomputer or the like. However, this conventional method has a great defect that it cannot cope with the distortion of the power supply voltage.

Also, according to the present embodiment, information (a wave form error signal) about a difference between the reference wave form and input current wave form is fed back from the wave form error detect circuit 92 to the gain variable amplifier circuit 91. As described above, the reference wave form is the wave form that has been obtained by converting a commercial power supply voltage wave form through the gain variable amplifier circuit 91, and the difference information between the reference wave form and input current wave form is further fed back to the gain variable amplifier circuit 91 to thereby provide the amplification control input signal of the gain variable amplification circuit 91, whereby the reference wave form is able to automatically follow the input current wave form in size. Thanks to this, in the difference information, only the wave form error can appear, so that the dynamic range of the wave form error detect circuit 92 can be kept wide and thus the characteristics of the circuit 92 can be improved.

Further, according to the present embodiment, the wave form error signal is fed back through the high frequency cut filter 910. This structure can remove the high frequency component of the wave form error signal. Therefore, when generating the reference wave form, the noise of the wave form error signal has no ill influence on the reference wave form, so that the reference wave form can be improved in shape.

Also, differently from the structure of the Japanese Patent Publication 2004-30981, there is eliminated the need for use of the auxiliary modulation signal 811 from the inversion/wave form processing circuit 263, the structure of the apparatus can be simplified and also the size thereof can be reduced easily.

Also, because of elimination of the auxiliary modulation signal 811, there is eliminated the need to adjust the auxiliary modulation signal 811 according to the kind and characteristic of the magnetron. And, it is possible to omit an individual design for each circuit corresponding to a magnetron to be mounted on the apparatus.

Further, with elimination of the auxiliary modulation signal 811, there can be eliminated the control operation in which the time of start of the first on operation of the transistor 239 is controlled to a phase in the vicinity of 0 degree, 180 degrees where the instantaneous voltage of the alternating voltage is small to thereby prevent a high voltage from being applied to the magnetron. This makes it possible to further simplify the structure of the apparatus.

And, in the structure of the Japanese Patent Publication Hei-7-136375, there are necessary the current detect means 271 such as CT and the rectifier circuit 272 which is used to rectify a current signal. On the other hand, according to the present embodiment, such operation is realized using the shunt resistor 71. Thanks to this, the apparatus can be simplified further, the apparatus can be reduced in size, and employment of ICs can be realized easily. However, there arises no problem when the current detect means 271 and rectifier circuit 272 shown in FIG. 13 are used instead of the shunt resistor 71 and input current signal amplifier 72 shown in FIG. 1.

### Embodiment 2

According to the embodiment 2, in the wave form error detect circuit 92, there is additionally provided a limiter for limiting the difference information (wave form error signal) in the positive and negative directions thereof, whereby the difference information is input to the mix circuit 81 through the limiter. Now, FIG. 5 is an explanatory view of the present embodiment. Specifically, FIG. 5A is a block diagram of the present embodiment, FIG. 5B is a characteristic view thereof, and FIG. 5C is a wave form view thereof. In FIG. 5A, reference numeral 921 designates a limit function which is disposed in the wave form error detect circuit 92 according to the present embodiment. When the reference wave form from the gain variable amplifier circuit 91 and the input current wave form from the rectifier circuit 72 are input to the input of the wave form error detect circuit 92, a wave form error is output through this limit function 921 to the mix circuit 81.

Referring to FIG. 5B, the vertical axis thereof expresses a wave form error value, while the horizontal axis thereof expresses an input current wave form. The reference wave form is applied to I0 in the horizontal axis. In the error detect characteristic, as shown in FIG. 5B, with I0 as a center, there continue a negatively sloping line L0, and two limit straight lines L1 and L2 which are disposed respectively after and before the line L0 and are used to limit the wave form error at a given level set according to the present embodiment.

FIG. 5C is a wave form view. Specifically, (1) is a view of a wave form applied to the horizontal axis and (2) shows the wave form of a wave form error signal appearing on the vertical axis. In (1), X designates a reference wave form, while Y stands for an input current wave form. D designates external disturbance. When the reference wave form X is applied to the horizontal axis 10, the input current wave form Y is swung about the reference wave form X; specifically, when the wave form Y is larger than the wave form X, the wave form Y is swung to the right in FIG. 5C and, when the wave form Y is smaller than the wave form X, the wave form Y is swung to the left in FIG. 5C. When a line extends upwardly perpendicularly to the swung position of the wave form Y and intersects with the error detect characteristic line L0, this intersecting point provides an error value. When the input current wave form Y is too large, the line intersects with the error detect characteristic line L1, with the result that the wave form error is limited. Also, when the input current wave form Y is too small, the line intersects with the error detect characteristic line L2, whereby the wave form is limited.

Therefore, the external disturbance D, which has entered the input current wave form Y, is limited in shape by the limit function, thereby reducing the influence of the disturbance D on the wave form error.

It has been empirically found that a phenomenon where the error signal exceeds the limit value is almost caused by the external disturbance. Thus, it is a problem that the disturbance enters the control system. Therefore, according to the present embodiment, the influence of the disturbance can be reduced.

Also, the present embodiment not only can prevent a possibility that the circuit can be saturated and unstable, but also can increase the gain of the input signal when the error is small. Thanks to this, the input current wave form is allowed to follow the reference wave form further better, which results in a secondary effect that the power factor of the circuit can be enhanced.

### Embodiment 3

According to the embodiment 3 of the invention, to the current control output, there is added a Vc limiter function which controls the collector voltage Vc of the switching transistor to a given value.

FIG. 6 is an explanatory view of a structure for adding the Vc limiter function to the current control output according to the embodiment 3. In this structure, to the circuit shown in FIG. 1, there is further added a comparator 740 which is shown by a dotted line in the lower portion of FIG. 6. This structure is shown in FIG. 2.

To one input terminal 742 of a comparator 745 of the comparator 740, there is input the collector voltage signal Vc of the switching transistor; and, to the other input terminal 743, there is input an applied voltage in the non-oscillating time of the magnetron as a voltage reference signal V2. A difference between the voltage signal Vc of the input terminal 742 and the voltage reference signal of the input terminal 743 is output from the comparator 745 to an output terminal 744, which is added to the output of the above-mentioned comparison circuit 74 to thereby provide an error signal.

Until the cathode of the magnetron is sufficiently warmed up to the temperature that allows the magnetron to oscillate, this comparator exhibits a characteristic which is equivalent to a high resistor but is different from the characteristic shown in FIG. 12. Therefore, for a period of time while the switching transistor 39 is in operation so as to allow a current to flow to a filament from the tertiary winding 42 of the transformer (FIG. 1) until the oscillation is allowed (which is hereinafter referred to as the non-oscillation time), a voltage to be applied to the primary winding 38 of the transformer 41 is limited to thereby prevent an overvoltage from being applied to the magnetron.

In other words, to the current control output, there is applied to the Vc limiter function in which, in the non-oscillation time of the magnetron, the voltage V2 is regarded as the voltage reference signal and this voltage reference signal is compared with the collector voltage Vc of the switching transistor 39 to thereby control the collector voltage Vc of the switching transistor 39 to a given value. This can simplify the inverter main circuit 10. By the way, in the oscillation time of the magnetron, this voltage reference signal is switched to a voltage V1 which is higher than the voltage V2 and, therefore, the voltage V2 is regarded substantially as invalid.

### Embodiment 4

An embodiment 4 is a modification of the high frequency component cut filter 910. FIG. 7A shows an example in which the high frequency cut filter 910 is included in the gain variable amplifier circuit 91. FIGS. 7B and 7C respectively show the examples of the structure of the cut filter 910.

### Embodiment 5

According to an embodiment 5 of the invention, there is provided reference signal conversion means which, in a phase where the commercial power supply voltage is low, allows the reference wave form signal to approach 0.

FIG. 8 is an explanatory view of a reference signal conversion circuit employed in the present embodiment. Specifically, FIG. 8A is a block diagram of the embodiment 5, FIG. 8B shows an example of a reference signal conversion circuit shown in FIG. 8A, and FIG. 8C is a wave form chart in which (1) designates a reference wave form and (2) stands for a wave form error signal.

In FIG. 8A, reference numeral 620 designates a reference signal conversion circuit. This reference signal conversion circuit 620 is interposed between the shaping filter 62 and gain variable amplifier 91 and is used to allow the reference wave form signal to approach 0 in a phase (in the vicinity of 0 degree, in the vicinity of 180 degrees) where a commercial power supply voltage is low.

In FIG. 8B, the reference signal conversion circuit 620 is configured as follows: that is, a transistor Tr62 is connected between a Vcc power supply and the input terminal of the gain variable amplifier 91, a direct voltage 62 is inserted between the base and earth of the transistor Tr62, and a resistor R62 is inserted upstream of a connecting point between the emitter of the transistor Tr62 and the input terminal of the gain variable amplifier 91.

Now, if the full wave rectification wave form Vs of an alternating current reaches the input terminal of the gain variable amplifier 91, when the voltage of the wave form Vs is larger than a given value V2, the transistor Tr62 is off and thus there can be obtained a full wave rectification wave form as it is.

On the other hand, when the voltage of the wave form Vs is smaller than the given value V2, the transistor Tr62 is on and thus the Vcc voltage is applied to the input terminal side; and, therefore, wave forms smaller than the given value V2 do not appear but there is provided a wave form which is raised by an amount corresponding to a given low potential portion. And, when the level of this wave form is shifted to match the low potential portion to 0, there can be obtained a desired wave form Vs′.

In FIG. 8C, (c) is an enlarged view of the wave form Vs′ and, as can be seen from FIG. 8C, in a phase (in the vicinity of 0 degree, in the vicinity of 180 degrees) where a commercial power supply voltage is low, the reference wave form signal approaches 0. Owing to use of such wave form, the control operation of the inverter main circuit can be stabilized. The reason for this is that, in a phase (in the vicinity of 0 degree, in the vicinity of 180 degrees) where a commercial power supply voltage is low, originally, a current is not allowed to flow in the magnetron and thus there is no need to issue a wave form error signal. Accordingly, when the reference wave form signal is previously set for 0 in a phase where the commercial power supply voltage is low, there is eliminated such operation that issues the wave form error signal to make the control unstable. In FIG. 8C, (2) designates a wave form error signal according to the prior art method and, as shown in FIG. 8C, in a phase (in the vicinity of 0 degree, in the vicinity of 180 degrees) where a commercial power supply voltage is low, the operation is easy to be unstable and the amplitude value C1 of the error signal is large. On the other hand, according to the present embodiment of the invention, the portion of C1, as shown by hatchings, is cut and, therefore, the circuit operation can be stabilized.

### Embodiment 6

According to an embodiment 6 of the invention, in the above-mentioned shaping circuit 62, there is provided a band-pass filter 621 as an example of a filter for damping the harmonic distortion component of a commercial power supply frequency to thereby complete a shaping filter circuit.

FIG. 9 is an explanatory view of the embodiment 6; and, specifically, FIG. 9A is a circuit diagram and FIG. 9B is a gain-frequency characteristic view.

In FIG. 9A, reference numeral 621 designates a band-pass filter which is provided in the shaping circuit 62 according to the embodiment 6. This band-pass filter 621 is used to dampen higher-order components which exceed a commercial power supply frequency.

FIG. 9B shows the gain-frequency characteristic of the band-pass filter 621, in which the higher-order harmonic distortion component of the commercial power supply frequency is cut, while the dampened amount of the lower-order harmonic distortion component of the commercial power supply frequency is small. As a result of this, since the lower-order distortion component of the commercial power supply frequency remains, as described in the embodiment 2, the power factor of the input signal according to the present embodiment is improved when compared with a conventionally used sine wave reference signal method using a microcomputer. Also, because the higher-order distortion component and noises are cut, the operation of the inverter circuit is stable and is strongly resistant against external disturbances.

### Embodiment 7

According to an embodiment 7 of the invention, the phase of the reference wave form in the previously described embodiment 1 is previously advanced with the delay time of the control system taken into account. This can enhance the power factor of the input signal. Here, FIG. 10 is an explanatory view of the embodiment 7; and, specifically, FIG. 10A is a circuit diagram and FIG. 10B is an explanatory view of the phase advance of the reference wave form.

In FIG. 10A, reference numeral 621 designates an example of a filter circuit provided according to the embodiment 7. Referring roughly to the configurations of the filter circuit 621, resistors R61, R62 and a capacitor C61 constitute a high-pass filter which cuts the low-band frequency component; resistors R63, R64 and a capacitor C62 constitute a low-pass filter for cutting the high-band frequency component; and, the resistors R61 and R62 are used to apply direct current bias.

In the above-mentioned filter, when the cut-off frequency of the low-pass filter is set higher than the power supply frequency and the cut-off frequency of the high-pass filter is set lower than the power supply frequency, there can be provided a band-pass filter having a characteristic which is the same as the gain-frequency characteristic shown in FIG. 10B.

Also, in the gain-frequency characteristic shown in FIG. 10B, the horizontal axis expresses the frequency of a signal to be input to the filter, while the vertical axis expresses variations in the phase of an output signal with respect to the frequency of the input signal. Since the above-mentioned low-pass filter is a phase delaying circuit and the high-pass filter is a phase advancing circuit, as shown in FIG. 10B, in the case of a frequency higher than the power supply frequency, the phase delays and, for a frequency lower than the power supply frequency, the phase advances. Here, when the above-mentioned cut-off frequency is set in such a manner that a frequency where the phase crosses 0 degree is slightly higher than the power supply frequency, as shown in FIG. 10B, the phase of a reference signal at the power supply frequency can be advanced by an advance amount ΔΦ.

Therefore, since the control system follows a reference signal, the phase of which is advanced with respect to the power supply voltage, with a slight delay, the phase of the input current wave form coincides with the power supply voltage, thereby being able to obtain a high power factor.

Although description has been given heretofore of various embodiments according to the invention, the invention is not limited to the contents of these embodiments, but the invention contains various changes and applications to be made by persons skilled in the art based on the disclosure of the present specification as well as based on the known technologies; that is, such changes and applications fall within the scope of the appended claims.

The present application is based on the Japanese Patent Application (Patent Application No. 2005-107639) filed on Apr. 4, 2005 and thus the contents of the application are incorporated into the present application for reference.

### INDUSTRIAL APPLICABILITY

According to a high frequency dielectric heating power control method of the invention, not only the structure of an apparatus can be simplified and the size of the apparatus can be reduced, but also there are eliminated the control and design according to the kinds of magnetrons to thereby be able to facilitate the control of the apparatus.

1. A high frequency dielectric heating power control method for controlling an inverter circuit for rectifying and high-frequency switching an alternating current power supply voltage to convert it to high frequency power, comprising the steps of:
detecting an input current to the inverter circuit to obtain an input current wave form;
obtaining a reference wave form following the size of the input current wave form according to an alternating current power supply voltage wave form from the alternating current power supply voltage;
comparing the input current wave form and the reference wave form to obtain a wave form error signal;
comparing the input current wave form and an input current reference signal for obtaining a desired high frequency output to obtain a current error signal;
adding the wave form error signal and the current error signal to obtain a power control signal for driving a switching transistor of the inverter circuit; and,
in the step of obtaining, generating the reference wave form based only on the alternating current power supply voltage wave form and on the feedback signal of the wave form error signal obtained in the comparing step.

2. A high frequency dielectric heating power control method as set forth in claim 1, wherein the reference wave form is obtained by converting a commercial power supply voltage wave form through a gain variable amplifier.

3. A high frequency dielectric heating power control method as set forth in claim 1, further including, before the adding step a step of limiting a wave form in the positive and negative directions of the wave form error signal.

4. A high frequency dielectric heating power control method as set forth in claim 1, wherein the generating step further includes a step of cutting the high frequency component of the feedback signal.

5. A high frequency dielectric heating power control apparatus for controlling an inverter circuit for rectifying and high-frequency switching an alternating current power supply voltage to convert it to high frequency power, comprising:
a current detect part for detecting an input current to the inverter circuit;
a first wave form conversion part for converting the input current to an input current wave form;
a second wave form conversion part for obtaining a reference wave form following the size of the input current wave form based on an alternating current power supply voltage wave form from the alternating current power supply voltage;
a wave form error detect circuit for comparing the input current wave form and the reference wave form to obtain a wave form error signal;
a comparison circuit for comparing the input current wave form with an input current reference signal for obtaining a desired high frequency output to obtain a current error signal; and,
a mix circuit for adding the wave form error signal and the current error signal to obtain a power control signal for driving a switching transistor of the inverter circuit,
wherein the reference wave form is generated based only on the alternating power supply voltage wave form and on the feedback signal of the wave form error signal.

6. A high frequency dielectric heating power control apparatus as set forth in claim 5, wherein the reference wave form is obtained by converting a commercial power supply voltage through the second wave form conversion part.

7. A high frequency dielectric heating power control apparatus as set forth in claim 5, wherein the second wave form conversion part includes a gain variable amplifier.

8. A high frequency dielectric heating power control apparatus as set forth in claim 5, further including a limiter for limiting a wave form in the positive and negative directions of the wave form error signal.

9. A high frequency dielectric heating power control apparatus as set forth in claim 5, further including a high frequency component cut filter for cutting the high frequency component of the feedback signal.

10. A high frequency dielectric heating power control apparatus as set forth in claim 5, wherein the first wave form conversion part includes an input current signal amplifier.

11. A high frequency dielectric heating power control apparatus as set forth in claim 5, wherein the current detect part is composed of a shunt resistor interposed between the alternating current power supply voltage and the inverter circuit.
